(19) United States
(12) Patent Application Publication
(10) Pub. No.: US 2015/0007548 A1
(43) Pub. Date: Jan. 8, 2015

(54) Rotary Pulse Detonation Engine

(71) Applicant: Gerald Eugene Cleverley, SR., Florence, KS (US)

(72) Inventor: Gerald Eugene Cleverley, SR., Florence, KS (US)

(73) Assignees: Gerald Eugene Cleverley, Sr., Florence, KS (US); Steven R Ewing, Wichita, KS (US)

(21) Appl. No.: 14/323,938

(22) Filed: Jul. 3, 2014

Related U.S. Application Data
(60) Provisional application No. 61/842,674, filed on Jul. 3, 2013.

(51) Int. Cl. F02C 3/16

(52) U.S. Cl. CPC F02C 3/165
USPC 60/39.34

(57) ABSTRACT

A rotary pulse detonation engine produces mechanical output by detonating a fuel/air mixture in detonation chambers between adjacent impeller blades. The impeller is housed within an outer casing and rotated around an inner sleeve. Air is passed through a velocity stack and through intake ports on the inner sleeve into the detonation chambers. Fuel is injected into the detonation chamber through fuel line(s). Igniters on the interior of the outer casing ignite the fuel and produce the detonations. Spent gas is released through exhaust ports situated on the outer casing, front plate or rear plate. The impeller may be supported by front and rear bearings in low speed applications, or by a pressurized cushion of air provided by exhaust gases directed to the front and rear ends of the impeller by a perforated tube sheet positioned between the impeller and the inner sleeve in high speed applications.

The current application claims a priority to the U.S. Provisional Patent application Ser. No. 61/842,674 filed on Jul. 3, 2013.

### FIELD OF THE INVENTION

The present invention relates generally to engines. More particularly, the present invention relates to a rotary engine for converting ignition bursts or detonations into rotation of an impeller.

### BACKGROUND OF THE INVENTION

Current designs for rotary engines, with the exception of the Wankel rotary engine, and CirCom CRX P1-5 rotary turbine engine utilize a separate combustion chamber, from which spent exhaust is used to power an impeller or rotor. The present invention instead draws energy from detonation, imparting rotation to an impeller through a resulting pressure wave and shockwave. Additionally, mechanical compression is no longer essential, instead trapped gasses within the spinning impeller produced by a subsequent time matrix prevents complete exhausting of generated gases, thereby creating a portion of pressurization for the fuel/air delivery. By deriving shockwave impulse energy from detonation, rather than combustion pressure to turn a crankshaft, a reduction of moving parts, and multiple firings per revolution of the impeller, the present invention is able to provide an improvement in engine design. Core concepts include an independent fuel line(s), individual combustion chambers formed within an impeller, inner sleeve, and outer casing, and an integrated combustion chamber (compared to separated combustion chambers commonly used in the prior art).

### BRIEF DESCRIPTION OF THE DRAWINGS

FIG. 1 is a perspective view of the present invention, showing exhaust ports and igniters.

FIG. 2 is a top perspective view of the present invention, further showing fuel lines.

FIG. 3 is a bottom perspective view of the present invention, further showing velocity stack and vortex generators.

FIG. 4 is an internal perspective view of the present invention.

FIG. 5 is a lateral internal view of the present invention.

FIG. 6 is an additional lateral internal view of the present invention.

FIG. 7 is a lateral view showing the plane upon which a cross-sectional view is taken and shown in FIG. 8.

FIG. 8 is a lateral section view taken along the line A-A of FIG. 7.

FIG. 9 is an additional lateral view showing the plane upon which a cross-sectional view is taken and shown in FIG. 10.

FIG. 10 is an additional lateral section view taken along the line B-B of FIG. 9.

FIG. 11 is a perspective view of a second embodiment of the present invention.

FIG. 12 is the perspective view of FIG. 11 with the outer casing removed.

FIG. 13 is side view of the second embodiment showing the plane upon which a cross-section view is taken and shown in FIG. 14.

FIG. 14 is a cross sectional view taken along the line C-C of FIG. 13.

FIG. 15 is a side view of the second embodiment with the outer casing removed.

FIG. 16 is a perspective view of the impeller only.

FIG. 17 is a perspective view of the velocity stack, front plate, inner sleeve, and perforated tube sheet.

FIG. 18 is a side view of an alternate arrangement of components with some hidden lines shown utilizing forward and rear bearings.

FIG. 19 is an illustration of the use of a control tab and a linear actuator to revolve the outer casing in order to align the exhaust ports relative to the igniters.

### SUMMARY OF THE INVENTION

An engine composed of an outer casing, a front plate, a rear plate, having multiple exhaust ports, an intake air tube assembly with multiple runners surrounded by a perforated tube sheet, a multiple vane impeller, a fuel injector or injectors, having a starter mechanism either pneumatic or electrical in origin.

The present invention requires only one internal moving component (impeller) suspended on a cushion of compressed air/exhaust gasses or in the case of an electrical motor/generator suspended by the shaft connection to the impeller.

The present invention is designed in such a fashion that the pressure of escaping exhaust gases (gas tube/port) not only A) heat the fuel/air combination but also B) pressurize the individual vane cavities in lieu of mechanical compression, therefore allowing internal pressures to be a function of fuel selection, pressure and velocity rather than mechanical in origin. Furthermore, a portion of those same exhaust gases C) not only stabilize the impeller fore and aft but also D) allow the impeller to levitate above the perforated tube sheet. Furthermore levitation of the spinning impeller eliminates the placement of internal bearings as well as the need for lubrication, both limiting factors to performance and longevity of any engine.

By replacing compression with pressurization via exhaust gas pressure an infinite ratio of pressurization within the rotating chambers may be achieved in lieu of a fixed compression ratio. Having ports vs. valves again reduces the necessity of additional moving parts. Additionally creating threaded connections both on the front and rear plates with respect to the outer casing allows finite adjustment of the placement of igniters with respect to the fixed intake and exhaust ports via linear actuator which allows performance to be similar to that of an impulse turbine.

The starter, whether pneumatic or electrical, can be mounted either internally or externally. Conversion of the Rotary Pulse Detonation Engine to a Reaction Engine simply requires the placement of additional fuel/chemical injectors appropriately mounted externally.

### DETAIL DESCRIPTIONS OF THE INVENTION

All illustrations of the drawings are for the purpose of describing selected versions of the present invention and are not intended to limit the scope of the present invention. The present invention is to be described in detail and is provided in a manner that establishes a thorough understanding of the present invention. There may be aspects of the present invention that may be practiced without the implementation of some features as they are described. It should be understood that some details have not been described in detail in order to not unnecessarily obscure focus of the invention.

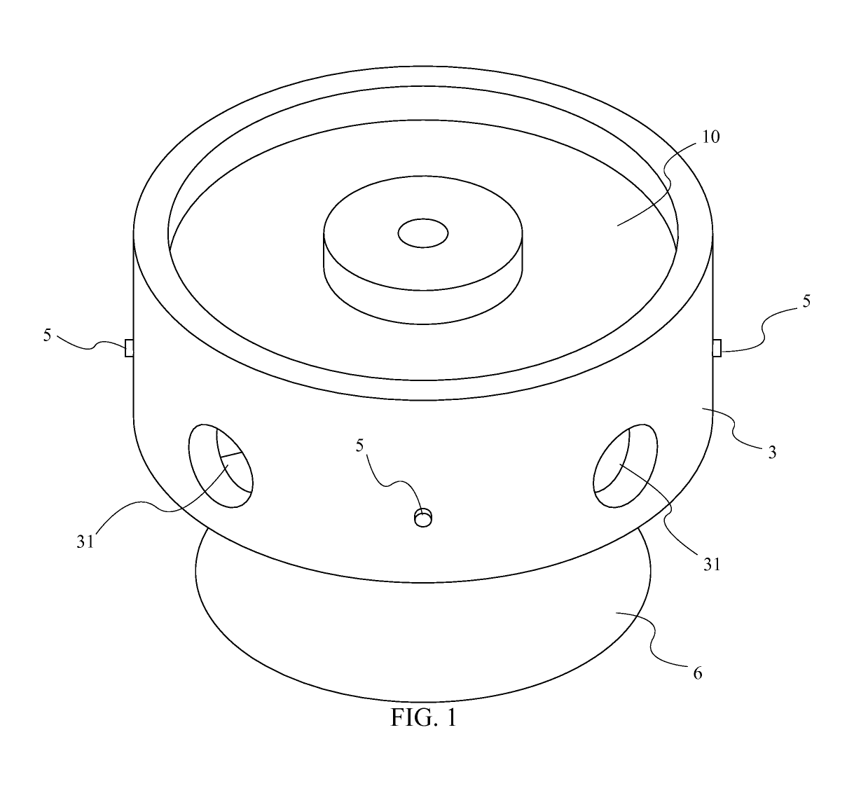

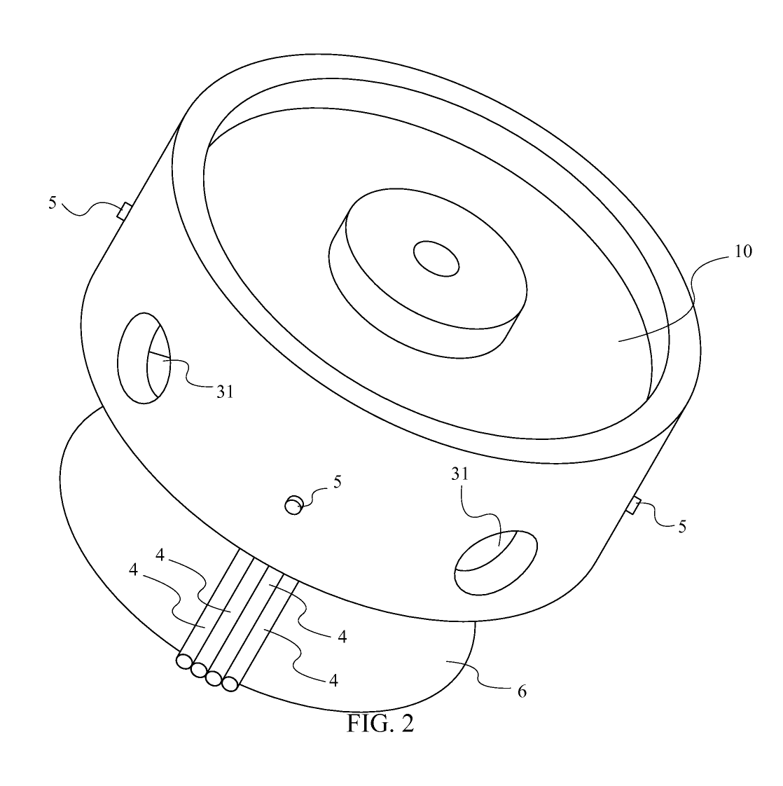

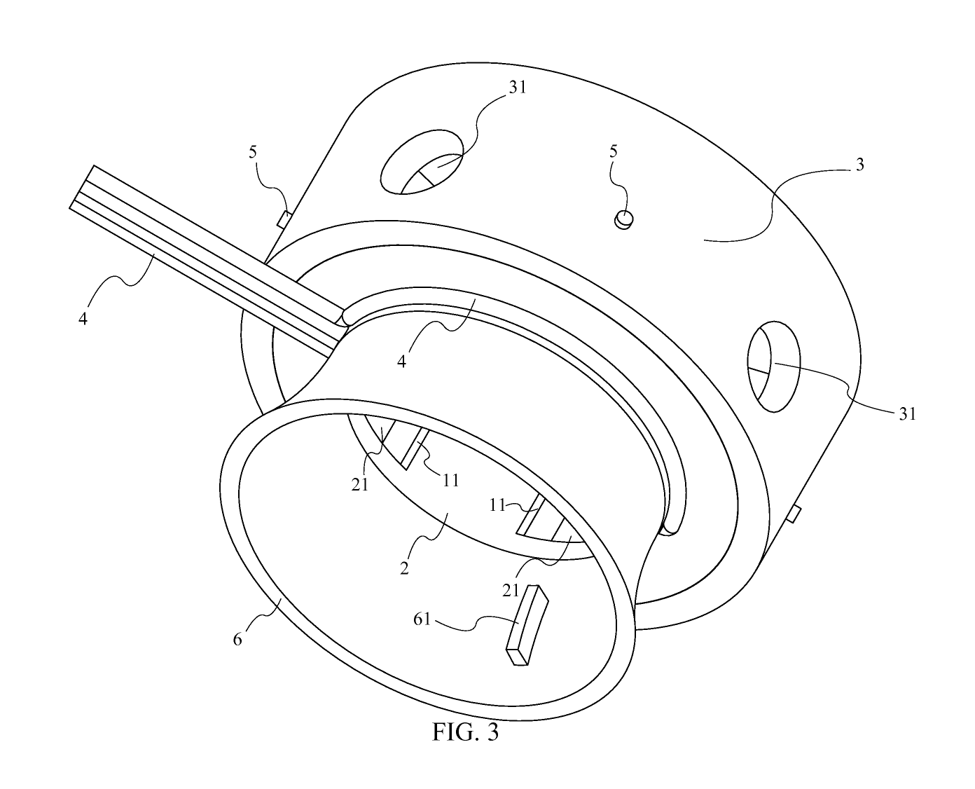

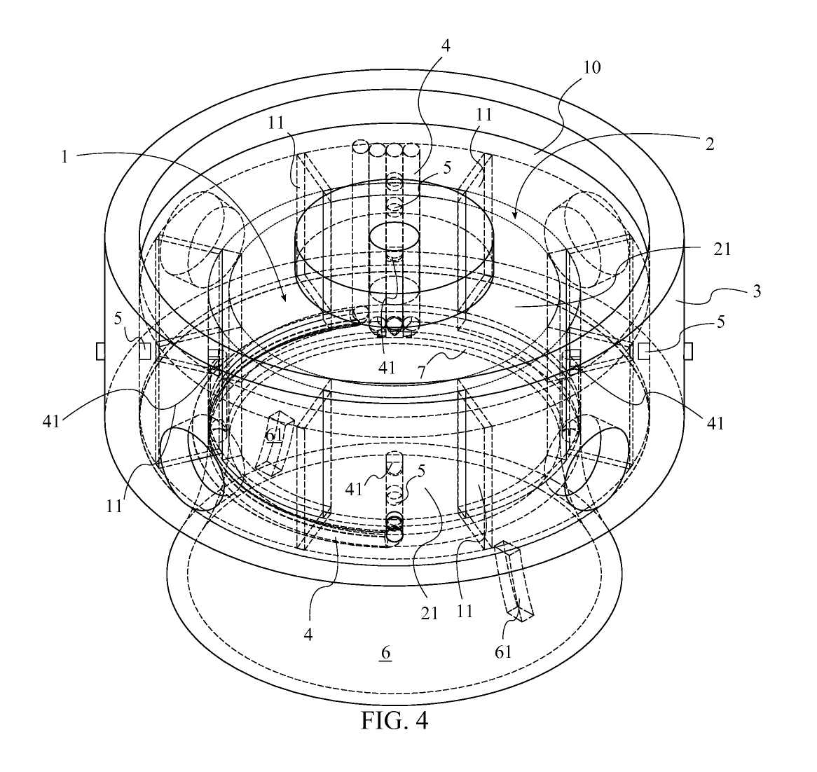

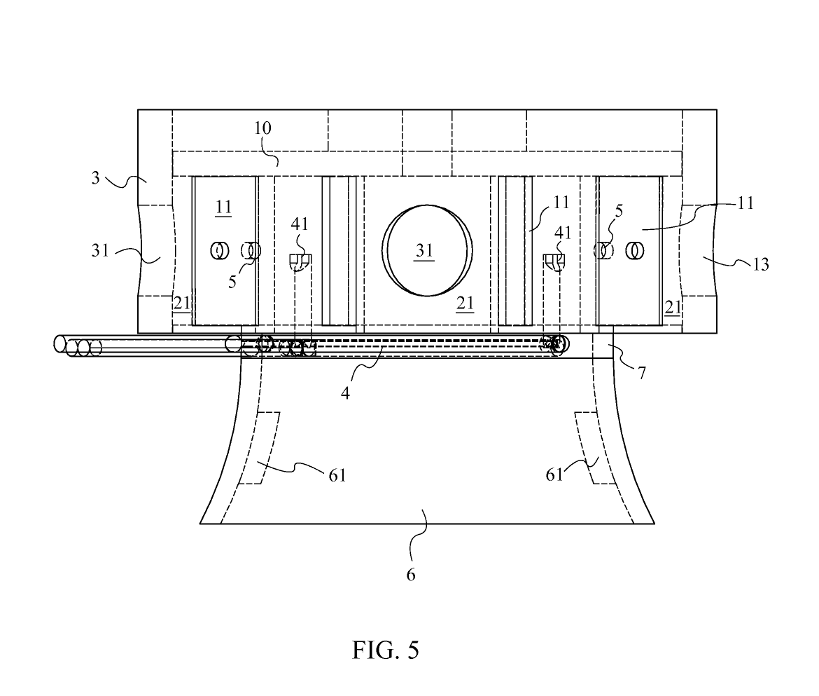

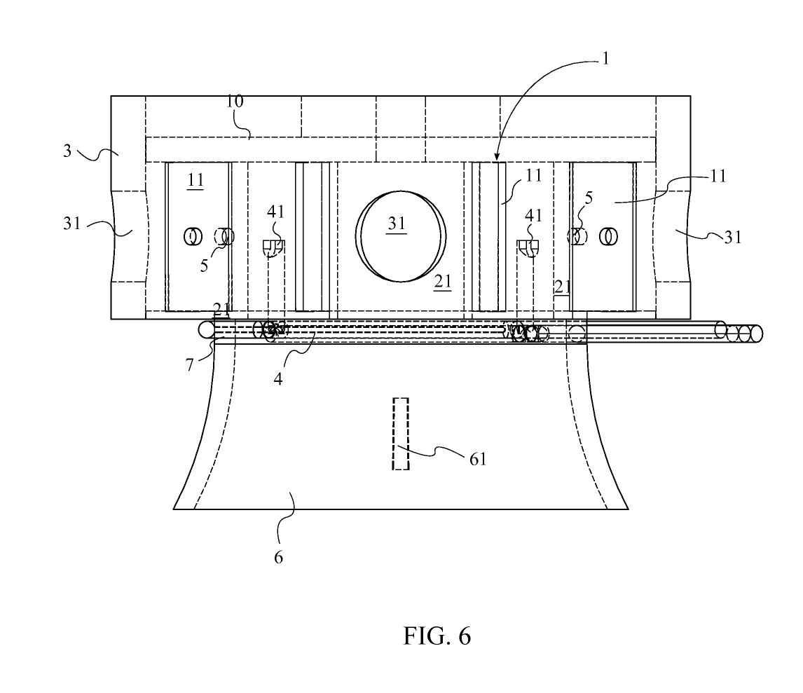

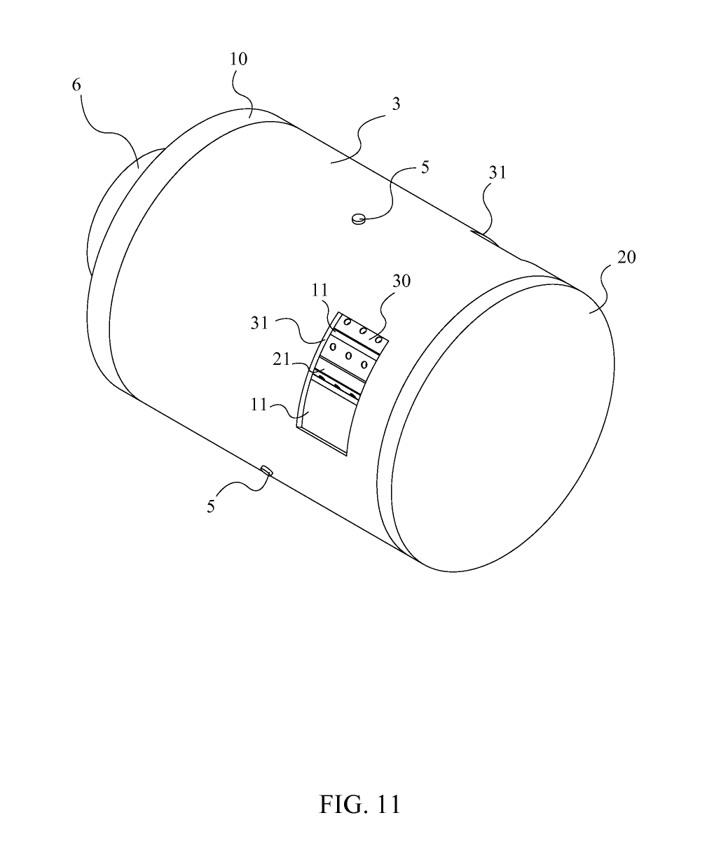

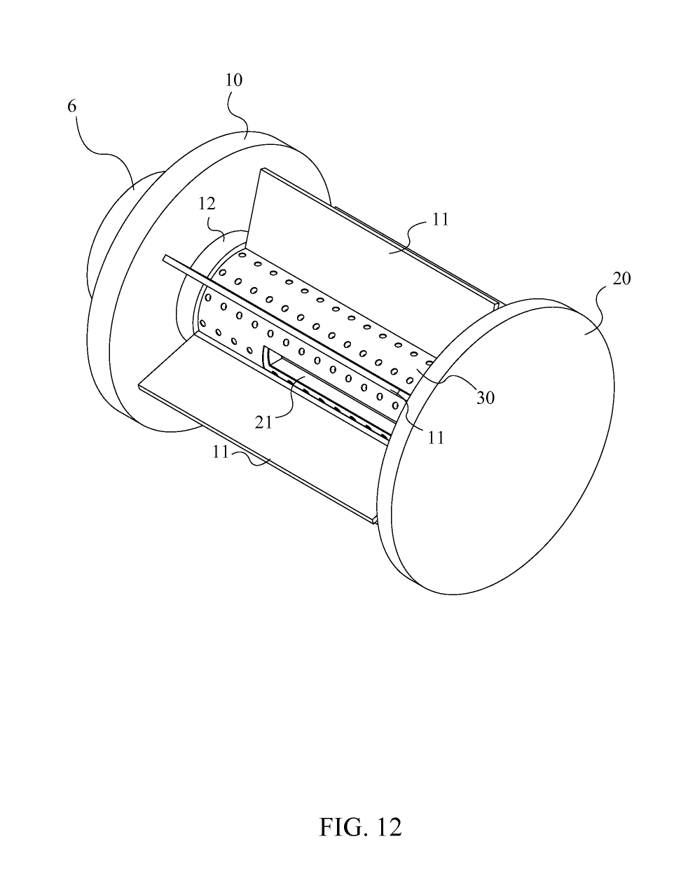

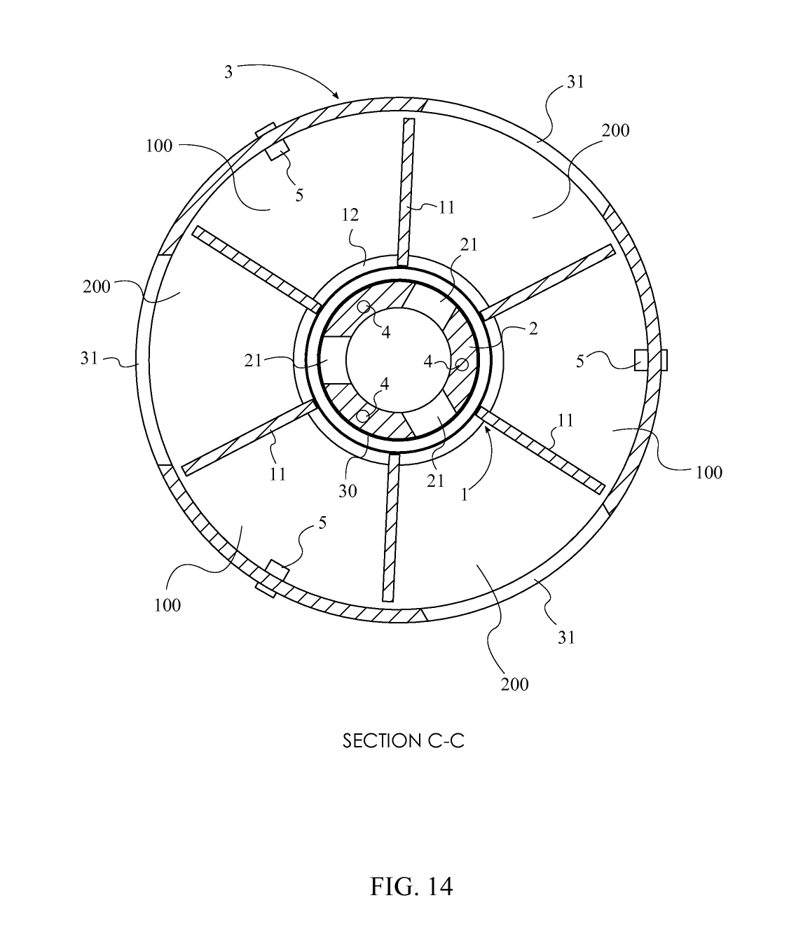

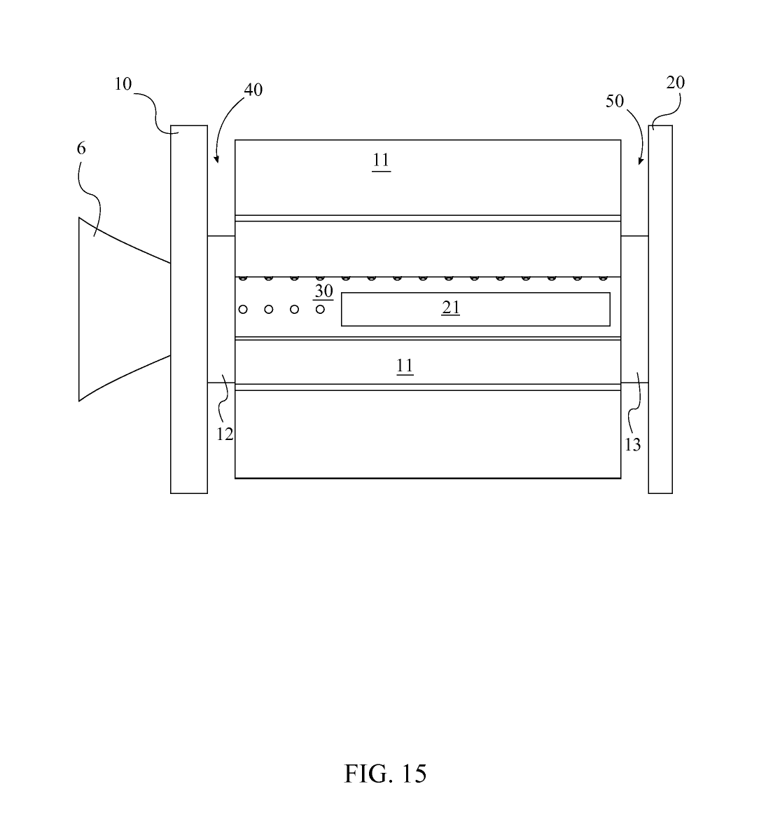

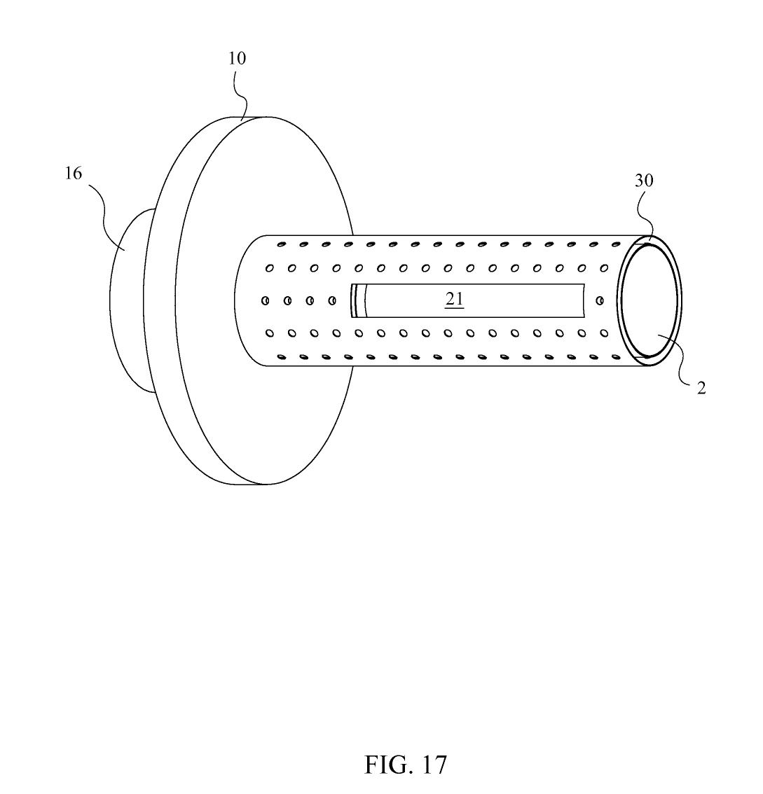

The present invention is a rotary engine using a pulse detonation process to produce mechanical output. Referring to FIGS. 1-6, the present invention comprises an impeller 1, an inner sleeve 2, an outer casing 3, a plurality of fuel lines 4, a plurality of igniters 5, and a velocity stack 6. An alternate embodiment is illustrated in FIGS. 11-17. The impeller 1, the inner sleeve 2, the outer casing 3, and the velocity stack 6 are positioned concentrically with each other. The impeller 1 encircles the inner sleeve 2, and the outer casing 3 encircles the impeller 1. The impeller 1 is housed within the outer casing 3 and rotates around the inner sleeve 2. The vanes 11 of the impeller 1 form individual detonation chambers 100 and intake/exhaust chambers 200 between the inner sleeve 2 and the outer casing 3. Fuel is injected into the detonation chambers 100 through fuel openings 41 on the inner sleeve 2 while vent gases from the detonations are expelled through exhaust ports 31 situated around the outer casing 3 or affixed on the front plate 10 or rear plate 20. The spaces between the vanes 11 alternate in the functions of delineating detonation chambers 100 and intake/exhaust chambers 200 as the vanes 11 rotate.

The design of the present invention provides several improvements to rotary engine designs. These improvements are as follows: eliminating the need for a mechanical starter, eliminating the need for compression, eliminating the need for auxiliary equipment (e.g. vane axial fans and external combustion chambers), only requiring a single rotating assembly (the impeller 1 and with/or without bearings), the creation of multiple reaction chambers, and introducing the use of vortex generators 61 within the velocity stack 6 in order to disrupt laminar air flow. The configuration of the present invention is designed to harness energy from detonation, unlike traditional engines which harness energy through combustive processes. A detonation is a supersonic explosion that produces a shockwave, whereas combustion is a chemical process that produces heat through the reaction between a fuel and an oxidant. The present invention generates a detonation by placing a starter (such as igniters 5 or chemical injectors) in the outer casing 3 and a reactant (supplied through pressurized chemical or fuel lines 4) which is formed or attached to the inner sleeve 2. The detonations are created in detonation chambers 100 which are delineated by the inner sleeve 2, the outer casing 3, and adjacent vanes 11 of the impeller 1.

As previously mentioned, the inner sleeve 2 comprises a plurality of intake ports 21 which are traversed through the inner sleeve 2. The plurality of intake ports 21 are angularly distributed around the inner sleeve 2. The outer casing 3 comprises a plurality of exhaust ports 31. The plurality of exhaust ports 31 are angularly distributed around the outer casing 3. Each of the plurality of intake ports 21 is angularly aligned with one of the plurality of exhaust ports 31, creating spaces for intake/exhaust chambers 200. Air moves through the velocity stack 6 and through the intake ports 21 to the detonation chambers 100 to provide air for the fuel/air mixture. Exhaust gases from the detonations are expelled through the exhaust ports 31.

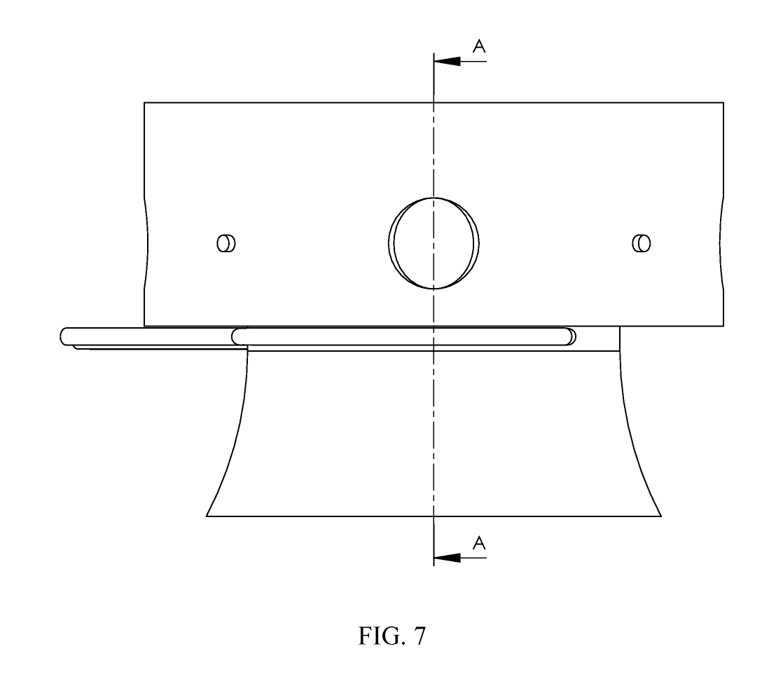

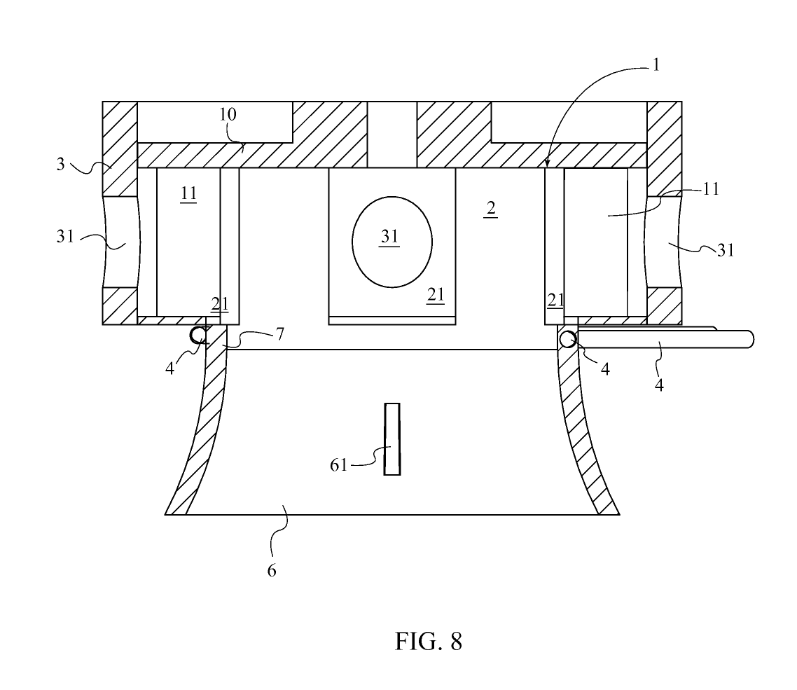

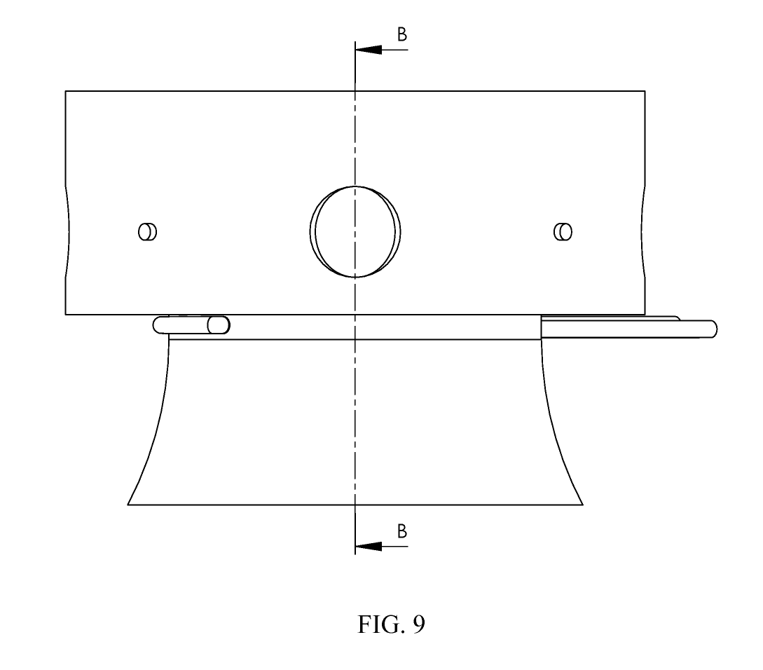

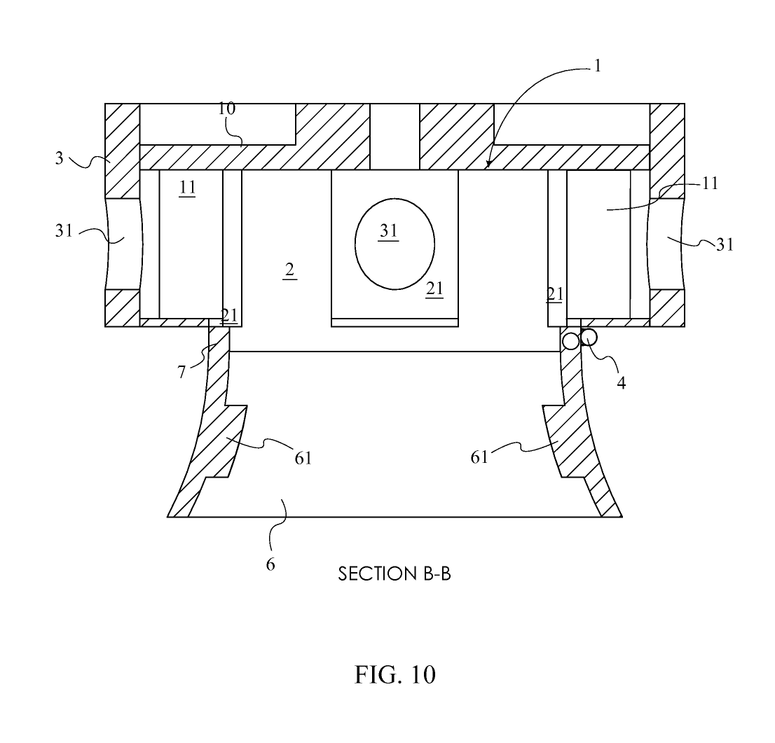

In the preferred embodiment of the present invention, the plurality of intake ports 21 and the plurality of exhaust ports 31 are equal in number. Additionally, the plurality of fuel lines 4 and the plurality of igniters 5 are preferably equal in number. The plurality of igniters 5 is connected to the outer casing 3, and is positioned within the outer casing 3 adjacent to the impeller 1 and therefore within the detonation chambers 100. The plurality of igniters 5 is alternatingly positioned with the plurality of exhaust ports 31. Preferably, the plurality of fuel lines 4 are positioned around the inner sleeve 2 and traverse through the body of the inner sleeve 2. A fuel opening 41 for each of the plurality of fuel lines 4 is positioned on the inner sleeve 2 adjacent to the impeller 1 and therefore adjacent to a detonation chamber 100. The fuel lines 4 are connected to an external purge and fuel valve manifold by a series of adjacent pipes. The fuel system can be singular (ported into the inner sleeve and/or air intake) or arranged so that each fuel line (or pipe) is independent from the other fuel lines 4. This design provides several advantages to the present invention. By increasing or decreasing the fuel supply and thereby controlling the number of detonation chambers 100 created the present invention can compensate for varying load and torque requirements. This is an aspect of the present invention that ultimately results in increased fuel efficiency. The arrangement of fuel lines and chambers is partially illustrated through section cuts as shown in FIG. 7-FIG. 10.

The fuel openings 41 are alternatingly positioned with the plurality of intake ports 21. Each of the fuel openings 41 are angularly aligned with one of the igniters 5, creating angular spaces where the detonations take place. This configurations results in detonation chambers 100 being separated from each other by intake/exhaust chambers 200, such that at any one time up to one half the total chambers are acting as detonation chambers 100 and the other half are acting as intake/exhaust chambers 200. For example, a detonation, created by fuel and an igniter, causes the impeller 1 to rotate. As the impeller 1 rotates, the vanes that contained the detonation become aligned with the intake ports 21 and the exhaust ports 31, effectively becoming an intake/exhaust chamber 200. At this point excess gases are expelled through the exhaust port while fresh air is pushed in from the intake port. This configuration creates a blow through design with respect to the intake and exhaust ports 31, one of the safety features of the present invention. As the impeller 1 rotates the chamber moves past the intake ports 21 and exhaust ports 31 and eventually approaching another igniter 5 and fuel opening 41. Upon encountering the next igniter 5 and fuel opening 41 a new detonation is created in the chamber. The repetition of this process allows the present invention to generate power from the shockwaves created by the detonations.

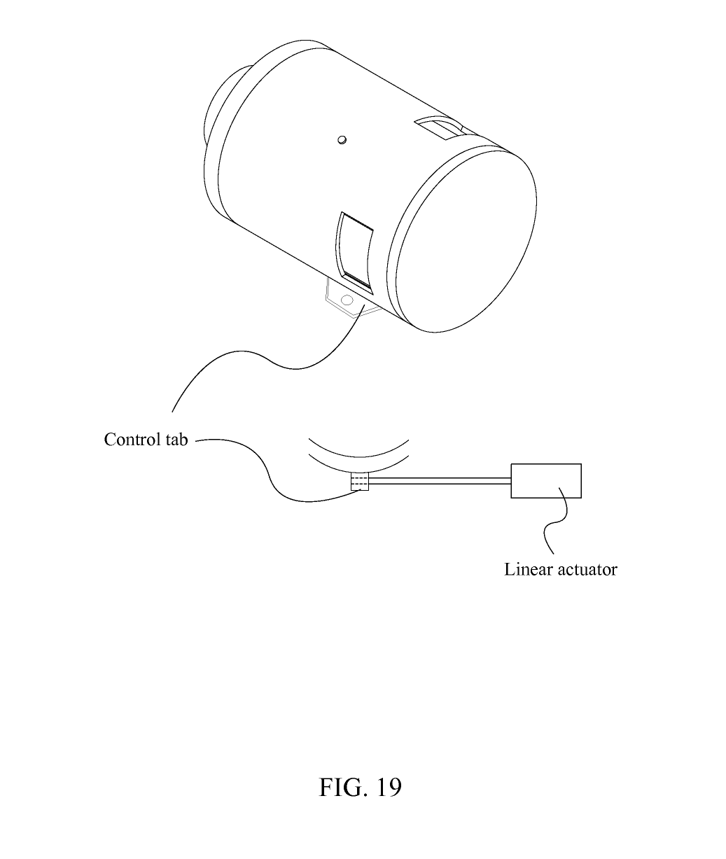

The air utilized by the present invention is guided through a velocity stack 6 which is connected to the outer casing 3 by a threaded end cap 7. The velocity stack 6 is positioned axially adjacent to the outer casing 3, and is connected to the outer casing 3 by a threaded end cap 7. A plurality of vortex generators 61 are connected within the velocity stack 6 and are angularly distributed within the velocity stack 6. The vortex generators 61 are used to disrupt laminar air flow and create turbulent air flow, since turbulent air flow is desired over laminar air flow for the functionality of the present invention. The threaded end cap 7 can be rotated slightly in relation to the outer casing 3 or vice versa, resulting in corresponding rotation of the outer casing 3 and thus the firing position and relationship to exhaust ports 31. The positional relationship between the igniters 5 and the exhaust ports 31 is important in creating a desirable shockwave which transfers energy to the impeller 1 in a manner which adds to rather than impedes the rotational motion of the impeller 1. The rotation adjustment is controlled through a linear actuator connected to a control tab positioned on the outer casing 3, as shown in FIG. 19. The ability to adjust the outer casing 3 is necessary as the alignment of the exhaust ports 31 needs to be slightly adjusted based on the rotations per minute (RPM) that the present invention is operated at. The velocity stack 6 funnels air into the inner sleeve 2, from which it can be transferred through the intake ports 21 into the intake/exhaust chambers 200.

The impeller 1 comprises a plurality of vanes 11 that are angularly distributed around the impeller 1 and spaced apart from each other. In the preferred embodiment of the present invention, each of the plurality of vanes 11 is oriented parallel to the axis of the impeller 1 and perpendicular to the inner surface of the outer casing 3, though it is contemplated that in alternate embodiments the vanes 11 may have various alternate orientations, such as, but not limited to, angled in order to produce a specific rotational direction. Different variations of the impeller 1 may be provided for the present invention. For example, the impeller 1 could be a single impeller 1, double sided, or even a grouping of multiple impeller is (more specifically the vanes 11 which form parts of the detonation and intake/exhaust chambers 200), comprising a rotating common shaft.

In low speed, low power operating applications where deflagration rather than detonation forces apply, a plurality of bearings are positioned adjacent to the impeller 1 and provide rotational support for the impeller 1. In the preferred embodiment, the plurality of bearings comprises a plurality of forward bearings 91 and a plurality of rear bearings 92. The plurality of forward bearings 91 are positioned adjacent to the velocity stack 6, and the plurality of rear bearings 92 are positioned adjacent to the impeller 1 opposite the plurality of forward bearings 91 so that the impeller 1 is supported in place between the plurality of forward bearings 91 and the plurality of rear bearings 92.

A second embodiment in lieu of physical bearing assemblies fore and aft of impeller is that of levitation by the recirculation of exhaust gases. It should be noted that the forward, front or fore end of the impeller is adjacent to the velocity stack, and the rear end is on the opposite end of the impeller. The second embodiment is shown in FIGS. 11-17. In the second embodiment, a perforated tube sheet 30 is positioned concentrically around the inner sleeve 2 between the inner sleeve 2 and the impeller 1. The perforated tube sheet 30 is positioned axially adjacent to the front plate 10 opposite the velocity stack 6, and the perforated tube sheet 30 is preferably connected to the front plate. With the perforated tube sheet 30, a portion of exhaust gases from previous ignitions do not exit through the exhaust ports 31 but rather travels back into the perforated tube sheet 30 and travels axially within the perforated tube sheet 30 toward the forward and rear ends of the impeller 1. In the preferred embodiment, the perforated tube sheet 30 is of a double wall construction, with an inner perforated wall being positioned adjacent to the inner sleeve 2 and an outer perforated wall being positioned adjacent to the impeller 1. The perforated tube sheet 30 should have slots that mimic size the intake ports 21 on the inner sleeve 2.

In the second embodiment, the impeller 1 comprises a front ring 12 and a rear ring 13, which are connected to the plurality of vanes 11 opposite each other, forming a blow-through design for the impeller 1. A forward space 40 is positioned between the impeller 1 and the front plate 10, and a rear space 50 is positioned between the impeller 1 and the rear plate 20. The forward space 40 and the rear space 50 are positioned adjacent to the perforated tube sheet 30, wherein a percentage of exhaust gases travel through the perforated tube sheet 30 into the forward space 40 and the rear space 50, creating pressure in the forward space 40 and the rear space 50 in order to support the impeller in place at high rotational speeds. The pressure in the forward space 40 and the rear space 50 essentially acts to levitate the impeller 1 within the outer casing 3, eliminating the need for bearings and thus removing components which could potentially fail. The portion of exhaust gases which function to levitate the impeller 1 press against the front ring 12 and the rear ring 13 concentrically, stabilizing the impeller 1 in place. Additionally, at high speeds exhaust gases from previous ignitions serve to heat any incoming fuel/air mixture, providing pressurization without mechanical compression.

A front plate 10 is positioned concentrically and axially adjacent with the inner sleeve 2 adjacent to the velocity stack 6. The front plate 10 encircles the inner sleeve 2, and is connected between the inner sleeve 2 and the velocity stack 6. In the second embodiment, the velocity stack 6, the front plate 10, and the inner sleeve 2 are all connected together as one piece. In the second embodiment, the front plate 10 additionally encircles a portion of the perforated tube sheet 30. The outer casing 3 is positioned concentrically with the front plate 10 and is connected axially adjacent to the front plate 10, wherein the front plate 10 seals the outer casing 3 adjacent to the velocity stack 6.

An rear plate 20 is positioned concentrically and axially adjacent with the outer casing 3 opposite the velocity stack 6, and the rear plate 20 is attached to the outer casing 3 by being threadedly engaged with the outer casing 3. The rear plate 20 seals the outer casing opposite the velocity stack 6. In order for the present invention to provide power to another device, a drive shaft must be connected to the impeller 1 adjacent to and through the rear plate 20. The drive shaft should traverse through the rear plate 20 through a seal in the rear plate 20.

Further benefits are realized from the arrangement of the detonation chambers 100, the intake ports 21, the exhaust ports 31, the fuel lines 4, and the starter. By providing a number of detonation chambers 100 (as formed by the impeller 1, inner sleeve 2, and outer casing 3), the amount of work required from each detonation is reduced. That is, a detonation only needs to rotate the impeller 1 by a few degrees before a new detonation chamber 100 is aligned with the starter and fuel line. Rather than requiring each detonation to power a full rotation of the impeller 1, each detonation is merely required to rotate the impeller 1 a fraction of a full rotation; yet, the force from a single detonation is sufficient to result in multiple rotations of the impeller 1. The high force and short rotational distance form a synergistic operating principle of the present invention. Providing an example of the resulting advantage, consider an embodiment of the present invention that utilizes an impeller 1 with 36 reaction chambers. Even though only half of the chambers act as detonation chambers 100 at any one time, in one full rotation this embodiment is capable of creating 648 detonations. In addition to the high number of detonations per rotation, each individual detonation is only required to rotate the impeller 1 by 10 degrees. The combination of high detonations per revolution and low degrees of rotation required from each detonation means the present invention has the potential to produce large amounts of torque and horsepower.

Due to various design aspects the present invention is less efficient at startup speeds, and therefore one goal is to quickly reach operating speed. One reason for decreased efficiency at startup speeds is the omission of seals for closing the chambers. This problem is eliminated at higher operating speeds, as a vacuum is naturally induced between the impeller 1 and the inner sleeve 2 as well as between the impeller 1 and the outer casing 3. Thus, when the impeller 1 is rotating at sufficient speeds the vacuum effectively creates a seal between both the impeller 1 and inner sleeve 2 and between the impeller 1 and outer casing 3. Because of the previously mentioned power provided by the configuration of chambers, it only takes a few seconds for the impeller 1 to reach operating speed in a no load situation. Resultantly, the drawbacks of not including seals in the design of the present invention are minimized. Another way the present invention becomes more efficient at speed is through a form of compression. Though the design of the present invention is designed to vent excess gases through the exhaust ports 31, at higher speeds some of the excess gas can not be physically exhausted, instead becoming trapped within the chamber. These trapped gasses result in the aforementioned compression, which further increases and accentuates the efficiency of the present invention beyond the initial pressurization of spent gasses used to heat and pressurize the fuel air mixture while allowing levitation of the spinning impeller.

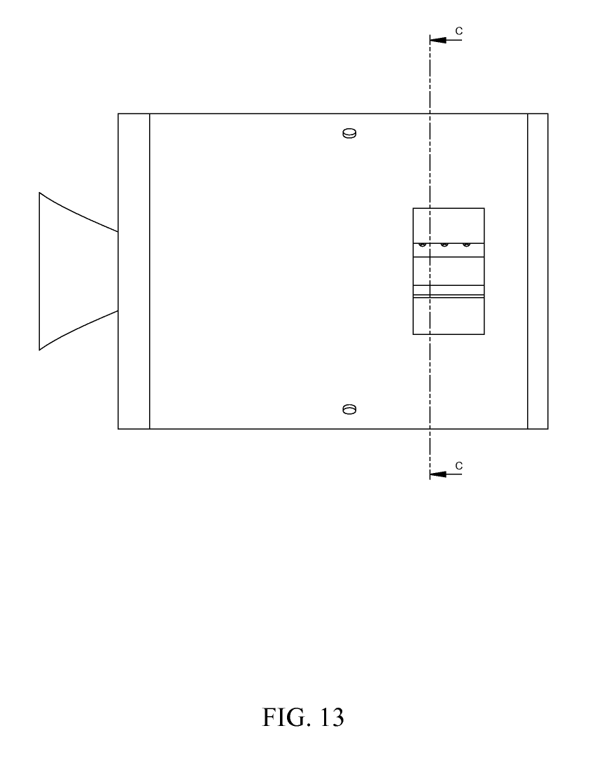

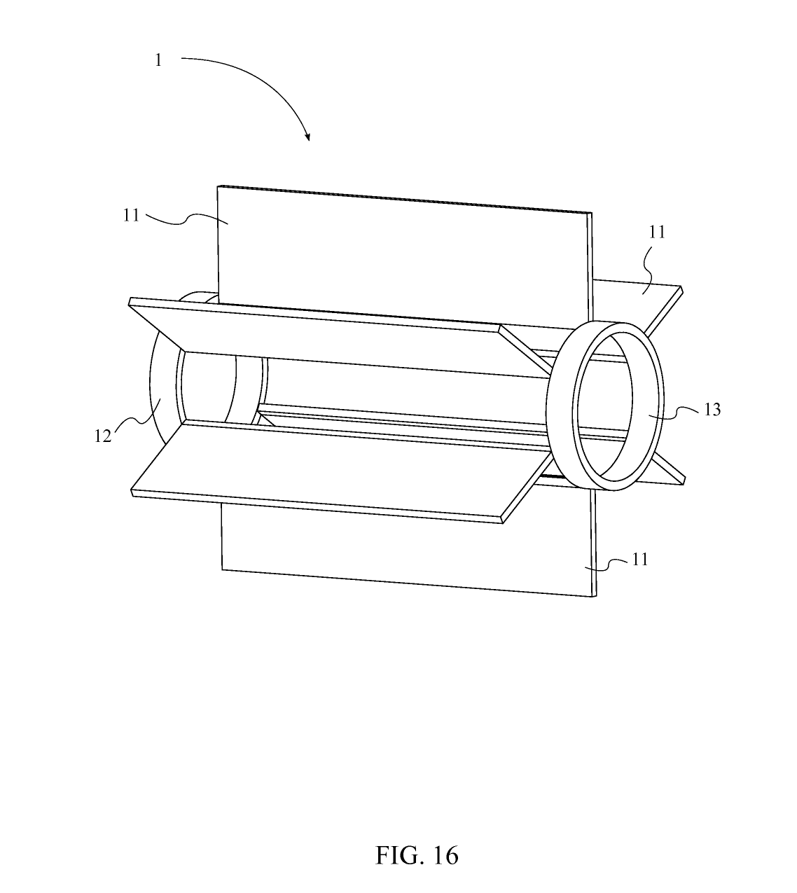

Since the present invention utilizes detonation to rotate an impeller 1 at high speeds several steps and components are provided in the interests of safety. Initial startup of the present invention includes verification of the ignition system (e.g. the igniters 5) and a purge cycle to verify impeller 1 rotation. The purge cycle pushes compressed air or exhaust gases through the impeller 1, ensuring that the impeller 1 is capable of rotating without any impediments. This impeller 1 verification is especially important as any faults with bearing rotation or blockages are dangerous at high rotational speeds; by testing with a purge cycle the present invention reduces the chances of serious injury resulting from an operational accident. This safety feature is visualized in FIGS. 13 and 16.

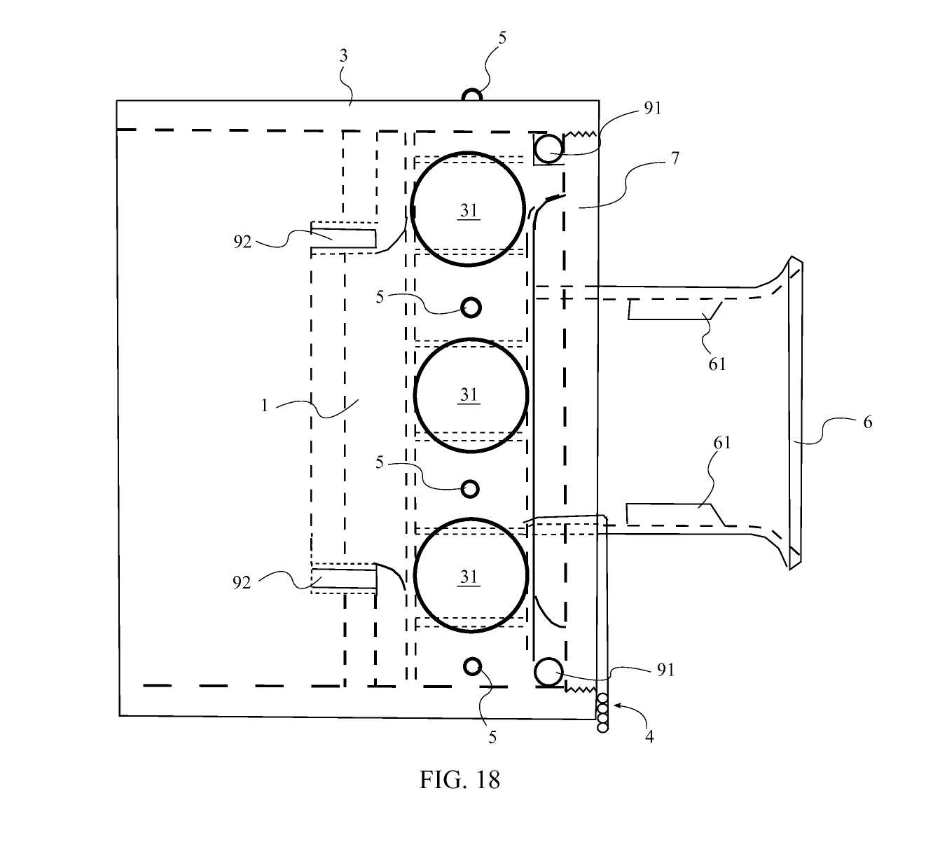

Preferably, the present invention is easily assembled by connecting two major component assemblies. The two major component assemblies, which encase the impeller 1, are the forward bearings 91, the threaded forward housing, the threaded outer casing 3 (impeller 1 section) housing, and the rear bearing 92. The forward bearing 91 is pressed with the threaded forward housing, while the rear bearing 92 is pressed onto the outer casing 3 (which may also referred to as the impeller 1 housing). The rear shaft of the impeller 1 is pressed onto the rear bearing and then screwed into the forward housing. An illustration for part of the assembly is provided in FIG. 18.

The present invention has numerous applications, as it can be utilized in exploration (such as deep sea and outer space), aerospace applications, domestic applications, electricity generation, and heating. Additional usage examples are military and commercial applications, including transportation and green energy HVAC systems. The present invention can be used to power a variety of devices, such as by being coupled to a vane hydraulic pump, a fluid coupling, a compressor, and an armature in a dynamo to be spun. Potentially, the present invention could also be designed to replace the compressor stage of a turbo jet fan engine, or be designed to provide sufficient exhaust gas to accentuate the operation of ram jet engines and scram jet engines, while able to create a high level of torque to the rotating shaft. The present invention can generate power from a number of fuels, an example of which includes methane. Methane is of particular interest as it is a renewable energy source, but other fuels and chemicals remain viable for use with the present invention.

Overall, the present invention is designed to capture and transfer the energy from detonation into rotational energy. The components and configuration of the present invention subsequently aid in the energy transfer process, provide secondary and tertiary benefits, and provide safety measures.

Although the invention has been explained in relation to its preferred embodiment, it is to be understood that many other possible modifications and variations can be made without departing from the spirit and scope of the invention as hereinafter claimed.

What is claimed is:

1. A rotary pulse detonation engine comprises:
an impeller;
an inner sleeve;
an outer casing;
a plurality of fuel line(s);
a plurality of igniters;
a velocity stack;
the impeller, the inner sleeve, the outer casing, and the velocity stack being positioned concentrically with each other;
the impeller encircling the inner sleeve;
the outer casing encircling the impeller;
the inner sleeve comprises a plurality of intake ports, wherein each of the plurality of intake ports traverses through the inner sleeve;
the plurality of intake ports being angularly distributed around the inner sleeve;
the outer casing comprises a plurality of exhaust ports;
the plurality of exhaust ports being angularly distributed around the outer casing;
each of the plurality of intake ports being angularly aligned with one of the plurality of exhaust ports;
the plurality of igniters being connected to the outer casing;
the plurality of igniters being alternatingly positioned with the plurality of exhaust ports;
a fuel opening for each of the plurality of fuel lines being positioned on the inner sleeve adjacent to the impeller;
the fuel openings being alternatingly positioned with the plurality of intake ports;
the velocity stack being positioned axially adjacent to the outer casing; and
the velocity stack being connected to the outer casing.

2. The rotary pulse detonation engine as claimed in claim 1 comprises:
the plurality of intake ports and the plurality of exhaust ports being equal in number.

3. The rotary pulse detonation engine as claimed in claim 1 comprises:
the plurality of fuel line(s) and the plurality of igniters being equal in number.

4. The rotary pulse detonation engine as claimed in claim 1 comprises:
the velocity stack being connected to the outer casing by a threaded end cap.

5. The rotary pulse detonation engine as claimed in claim 1 comprises:
a control tab being positioned on the outer casing opposite the impeller; and
a linear actuator being connected to the control tab, wherein the linear actuator is used to rotate the outer casing in order to align the plurality of exhaust ports with respect to the plurality of igniters.

6. The rotary pulse detonation engine as claimed in claim 1 comprises:
the plurality of fuel line(s) traversing through the inner sleeve.

7. The rotary pulse detonation engine as claimed in claim 1 comprises:
the plurality of igniters being positioned within the outer casing adjacent to the impeller.

8. The rotary pulse detonation engine as claimed in claim 1 comprises:
the impeller comprises a plurality of vanes; and
the plurality of vanes being angularly distributed around the impeller.

9. The rotary pulse detonation engine as claimed in claim 8 comprises:
the plurality of vanes being equally spaced apart from each other.

10. The rotary pulse detonation engine as claimed in claim 8 comprises:
each of the plurality of vanes being oriented parallel to the axis of the impeller and perpendicular to the inner surface of the outer casing.

11. The rotary pulse detonation engine as claimed in claim 1 comprises:
a plurality of bearings; and
the plurality of bearings being positioned adjacent to the impeller.

12. The rotary pulse detonation engine as claimed in claim 11 comprises:
the plurality of bearings comprises a plurality of forward bearings and a plurality of rear bearings.
the plurality of forward bearings being positioned adjacent to the velocity stack;
the impeller being positioned between the plurality of forward bearings and the plurality of rear bearings.

13. The rotary pulse detonation engine as claimed in claim 1 comprises:
a front plate;
the front plate being positioned concentrically and axially adjacent with the inner sleeve adjacent to the velocity stack;
the front plate encircling the inner sleeve; and
the front plate being connected between the inner sleeve and the velocity stack.

14. The rotary pulse detonation engine as claimed in claim 13 comprises:
the front plate encircling a perforated tube sheet, wherein the perforated tube sheet encircles the inner sleeve.

15. The rotary pulse detonation engine as claimed in claim 13 comprises:
the outer casing being positioned concentrically with the front plate; and
the outer casing being connected axially adjacent to the front plate, wherein the front plate seals the outer casing adjacent to the velocity stack.

16. The rotary pulse detonation engine as claimed in claim 1 comprises:
a rear plate;
the rear plate being positioned concentrically and axially adjacent with the outer casing opposite the velocity stack; and
the rear plate being attached to the outer casing.

17. The rotary pulse detonation engine as claimed in claim 16 comprises:
the rear plate being threadedly engaged with the outer casing, wherein the rear plate seals the outer casing opposite the velocity stack.

18. The rotary pulse detonation engine as claimed in claim 1 comprises:
a perforated tube sheet;
the perforated tube sheet being double walled;
the perforated tube sheet being positioned concentrically around the inner sleeve between the inner sleeve and the impeller;
the perforated tube sheet being positioned axially adjacent to the front plate opposite the velocity stack; and
the perforated tube sheet being connected to the front plate.

19. The rotary pulse detonation engine as claimed in claim 17 comprises:
a forward space being positioned between the impeller and the front plate;
a rear space being positioned between the impeller and the rear plate; and
the forward space and the rear space being positioned adjacent to the perforated tube sheet and opposite each other across the perforated tube sheet, wherein exhaust gases travel through the perforated tube sheet into the forward space and the rear space, creating pressure in the forward space and the rear space in order to support the impeller in place at high rotational speeds.

20. The rotary pulse detonation engine as claimed in claim 1 comprises:
a plurality of vortex generators;
the plurality of vortex generators being connected within the velocity stack; and
the plurality of vortex generators being angularly distributed within the velocity stack.
